(19) United States
(12) Patent Application Publication
(10) Pub. No.: US 2020/0208986 A1
(43) Pub. Date: Jul. 2, 2020

(54) SYSTEMS, METHODS, AND STORAGE MEDIA FOR PROVIDING NAVIGATION DIRECTIONS

(71) Applicants: Anshuman Mishra, Erie, CO (US); Divyam Mishra, Erie, CO (US)

(72) Inventors: Anshuman Mishra, Erie, CO (US); Divyam Mishra, Erie, CO (US)

(21) Appl. No.: 16/236,159

(22) Filed: Dec. 28, 2018

(51) Int. Cl. G01C 21/20; G06N 3/04; G06F 16/907; G06F 1/16

(52) U.S. Cl. CPC G01C 21/206; G06F 1/163; G06F 16/907; G06N 3/04

(57) ABSTRACT

Systems, methods, and storage media for providing navigation directions are disclosed. Exemplary implementations may: receive, by a field programmable gate array (FPGA), a first set of data from at least one sensor, the FPGA and the at least one sensor included in a wearable device worn by a user, perform at least one of a max-pooling operation and a convolution operation on the first set of data to produce processed data; transmit the processed data to a remote server to cause the remote server to train a machine learning model using the processed data to compute at least one weight, at least one layer, and at least one hyperparameter of the machine learning model; receive, from the remote server, a copy of the metadata file; and store the metadata file on the wearable device.

### FIELD OF THE DISCLOSURE

The present disclosure relates to systems, methods, and storage media for providing navigation directions.

### BACKGROUND

International travelers may have difficulty navigating foreign destinations, including airports. For example, it is not uncommon to see increased use of kiosks for check-in, baggage handling, security checks, immigration and customs, etc. In addition, for foreign travelers, cabin announcements and interactions with kiosks may take place in an unfamiliar language. It can therefore be difficult for some travelers, particularly elderly travelers, to navigate through foreign destinations efficiently.

### SUMMARY

One aspect of the present disclosure relates to a system configured for providing navigation directions. The system may include one or more hardware processors configured by machine-readable instructions. The processor(s) may be configured to receive, by a field programmable gate array (FPGA), a first set of data from at least one sensor, the FPGA and the at least one sensor included in a wearable device worn by a user. The processor(s) may be configured to perform at least one of a max-pooling operation and a convolution operation on the first set of data to produce processed data. The processor(s) may be configured to transmit the processed data to a remote server to cause the remote server to train a machine learning model using the processed data to compute at least one weight, at least one layer, and at least one hyperparameter of the machine learning model. The remote server may store a metadata file including the at least one weight, the at least one layer, and the at least one hyperparameter of the machine learning model. The processor(s) may be configured to receive, from the remote server, a copy of the metadata file. The processor(s) may be configured to store the metadata file on the wearable device.

In some implementations of the system, the processor(s) may be configured to compress the processed data prior to transmitting the processed data to the remote server.

In some implementations of the system, the machine learning model may include a neural network.

In some implementations of the system, the processor(s) may be configured to receive a second set of data from the at least one sensor on the wearable device.

In some implementations of the system, the processor(s) may be configured to process the second set of data via an instance of the machine learning model and the metadata file stored on the wearable device to generate a prediction relating to a navigation direction.

In some implementations of the system, the processor(s) may be configured to output the prediction to the user of the wearable device.

Another aspect of the present disclosure relates to a method for providing navigation directions. The method may include receiving, by an FPGA, a first set of data from at least one sensor, the FPGA and the at least one sensor included in a wearable device worn by a user. The method may include performing at least one of a max-pooling operation and a convolution operation on the first set of data to produce processed data. The method may include transmitting the processed data to a remote server to cause the remote server to train a machine learning model using the processed data to compute at least one weight, at least one layer, and at least one hyperparameter of the machine learning model. The remote server may store a metadata file including the at least one weight, the at least one layer, and the at least one hyperparameter of the machine learning model. The method may include receiving, from the remote server, a copy of the metadata file. The method may include storing the metadata file on the wearable device.

In some implementations of the method, it may include further including compressing the processed data prior to transmitting the processed data to the remote server.

In some implementations of the method, the machine learning model may include a neural network.

In some implementations of the method, it may include further including receiving a second set of data from the at least one sensor on the wearable device.

In some implementations of the method, it may include further including processing the second set of data via an instance of the machine learning model and the metadata file stored on the wearable device to generate a prediction relating to a navigation direction.

In some implementations of the method, it may include further including outputting the prediction to the user of the wearable device.

Yet another aspect of the present disclosure relates to a non-transient computer-readable storage medium having instructions embodied thereon, the instructions being executable by one or more processors to perform a method for providing navigation directions. The method may include receiving, by an FPGA, a first set of data from at least one sensor, the FPGA and the at least one sensor included in a wearable device worn by a user. The method may include performing at least one of a max-pooling operation and a convolution operation on the first set of data to produce processed data. The method may include transmitting the processed data to a remote server to cause the remote server to train a machine learning model using the processed data to compute at least one weight, at least one layer, and at least one hyperparameter of the machine learning model. The remote server may store a metadata file including the at least one weight, the at least one layer, and the at least one hyperparameter of the machine learning model. The method may include receiving, from the remote server, a copy of the metadata file. The method may include storing the metadata file on the wearable device.

In some implementations of the computer-readable storage medium, the method may include further including compressing the processed data prior to transmitting the processed data to the remote server.

In some implementations of the computer-readable storage medium, the machine learning model may include a neural network.

In some implementations of the computer-readable storage medium, the method may include further including receiving a second set of data from the at least one sensor on the wearable device.

In some implementations of the computer-readable storage medium, the method may include further including processing the second set of data via an instance of the machine learning model and the metadata file stored on the wearable device to generate a prediction relating to a navigation direction.

In some implementations of the computer-readable storage medium, the method may include further including outputting the prediction to the user of the wearable device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A illustrates two perspective views of a wearable device, in accordance with one or more implementations.

FIG. 1B illustrates a headset that can be included in the wearable device of FIG. 1A, in accordance with one or more implementations.

FIG. 2 illustrates a system configured for providing navigation directions, in accordance with one or more implementations.

FIG. 3 illustrates a system configured for providing navigation directions, in accordance with one or more implementations.

FIG. 4 illustrates a method for providing navigation directions, in accordance with one or more implementations.

### DETAILED DESCRIPTION

International travelers often must navigate through airports and perform tasks related to custom forms, baggage, and immigration in languages they are not familiar with. In addition, kiosks, cabin announcements, in-flight entertainment systems, check-in apps, loyalty programs etc. may not have any common design elements across airlines and airports. While some travelers may adapt quickly to be able to handle these challenges, others find it increasingly difficult to cope with this diverse technology-driven air travel. This disclosure provides systems and methods for a wearable device that can serve as a virtual travel companion. For example, using the systems and methods disclosed herein, a traveler may be able to receive automated directions for navigating through an airport based on artificial intelligence predictions, or may be able to receive assistance remotely from a trusted person, such as a relative.

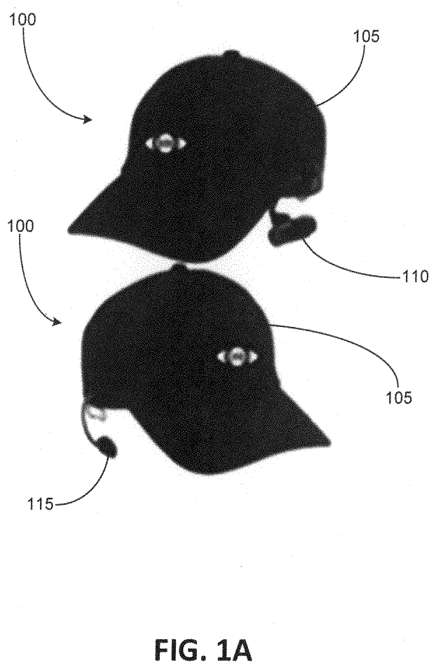

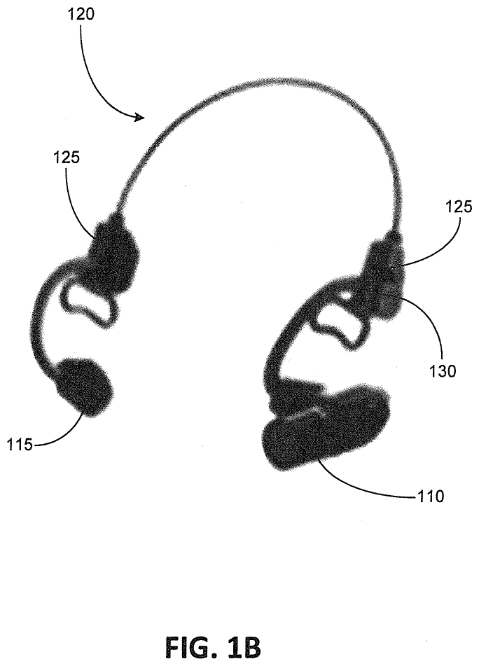

FIG. 1A illustrates two perspective views of a wearable device 100, in accordance with one or more implementations. The wearable device 100 includes a cap 100 that can be worn by a user. The wearable device 100 also can include a plurality of sensors, such as a camera 110 and a microphone 115, for capturing real-time data from an external environment. FIG. 1B illustrates a headset 120 that can be included in the wearable device 100 of FIG. 1A, in accordance with one or more implementations. As shown, the camera 110 and the microphone 115 can be mounted to the headset 120. The headset 120 can also include output devices, such as speakers 125. The headset 120 can also include a wearable computing device 130. The wearable device 100 can also include a variety of other sensors and computing devices not shown, such as a GPS location monitoring device.

A traveler can wear the wearable device 100 when progressing through an airport. The camera 110 be oriented such that it can capture what is visible to the traveler. The camera 110, the microphone 115, and/or the wearable computing device 130 can also stream the video and/or audio signals from the camera 110 and microphone 115 to a mobile application executed by a remote computing device, for example via a cloud-based application. In some implementations, the remote computing device can be accessed by another user, such as a relative or other person trusted by the traveler who wears the wearable device 100. As a result, the other user may monitor what the traveler is seeing and hearing in real time. In some implementations, the other user also can provide information back to the wearable device (e.g., via the speakers 125), so that the other user can communicate with the traveler wearing the wearable device 100 to provide real-time assistance. For example, the other user can be able to see and hear what the traveler sees, and can communicate with the traveler in the traveler's native language, if the traveler requires assistance.

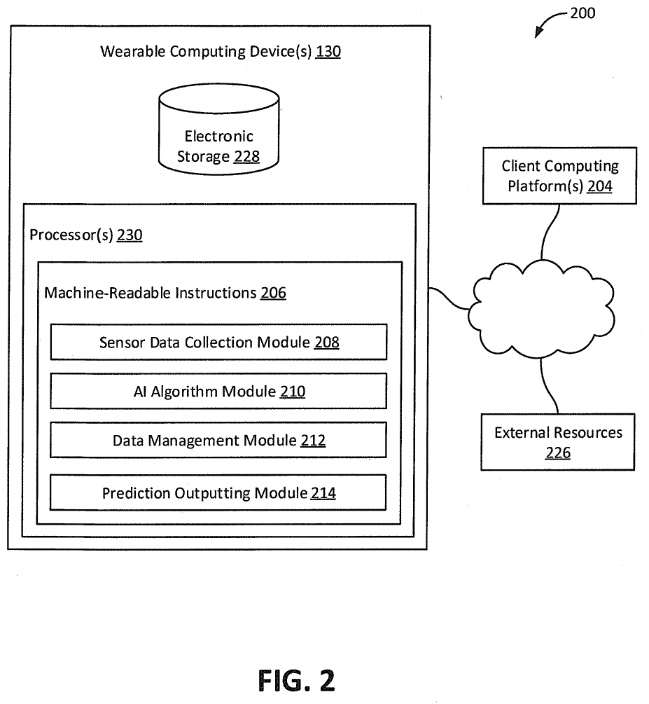

In some implementations, the wearable device 100 may also include artificial intelligence (AI) functionality to allow the wearable device 100 to learn travel patterns over time such that the wearable device 100 can provide predictions to the traveler (e.g., provide directions for navigating through an airport via the speakers 125. An example system for providing such functionality is shown in FIG. 2. FIG. 2 illustrates a system 200 configured for providing navigation directions, in accordance with one or more implementations. In some implementations, system 200 may include one or more wearable computing devices 130, similar to that shown in FIG. 1 as part of the wearable device 100. Wearable computing device(s) 130 may be configured to communicate with one or more client computing platforms 204 according to a client/server architecture and/or other architectures. For example, one or more of the client platforms 204 may be a computing device accessed by a user for remotely monitoring and communicating with the wearer of the wearable device 100 in real time. Client computing platform(s) 204 may be configured to communicate with other client computing platforms 204 via wearable computing device(s) 130 and/or according to a peer-to-peer architecture and/or other architectures. Users, such as those who wish to monitor the wearer of the wearable device 100, may access system 200 via client computing platform(s) 204.

Wearable computing device(s) 130 may be configured by machine-readable instructions 206. Machine-readable instructions 206 may include one or more instruction modules. The instruction modules may include computer program modules. The instruction modules may include one or more of a sensor data collection module 208, an AI algorithm module 210, a data management module 212, a prediction outputting module 214, and/or other instruction modules.

Sensor data collection module 208 may be configured to receive, a first set of data from at least one sensor. For example, the data can be received from a sensor such as the camera 110 or the microphone 115 shown in FIG. 1. In some implementations, the wearable computing device 130 may include a field programmable gate array (FPGA) for receiving and/or processing the data collected by the sensor data collection module 208. In some implementations, the 208 itself may include one or more sensors, such as a GPS location monitoring device, configured to collect sensor data.

The system 200 may implement machine learning techniques to process the sensor data and make predictions that can be used by the traveler in real time. For example, the system 200 can implement a deep neural network (DNN) or other machine learning model. Such a DNN may require a large set of test data over time that can allow the DNN to calculate hyperparameters and weights associated with an AI algorithm over time. This can be referred to as “training” the DNN. The goal could be to learn patterns at airports over time and offer features to achieve the functionality of a virtual travel companion. For example, the system 200 could tell the user where to navigate based on images of signs and pathways the DNN is given. Using calculated weights, the model can accurately predict the surroundings of a user and navigate them around an airport.

In some implementations, the AI algorithm module 210 can be used to implement a neural network. For example, the AI algorithm module 210 can be or can include all of the necessary hardware for receiving training data, training a DNN or other machine learning model, and using the model to process newly acquired data to make predictions in real time. However, such an approach may be time consuming and inefficient given the computing resources and power available for a wearable device such as the wearable device 100. For example, to train a DNN may require a huge amount of test data. This training can take a long period of time as typical central processing units (CPUs, such as the processors 230) use sequential processing to compute a plethora of mathematical operations to train a neural network. Even using more efficient hardware, such as one or more FPGAs or graphics processing units (GPUs) could still be prohibitively time consuming and computationally inefficient to perform on the wearable computing device 130.

To improve the speed and efficiency with which data analytics, convolution, and other computations can be performed on training data for the DNN, in some implementations the wearable computing device 130 can offload some of the computational work to a remote cloud device, which may be included in the external resources 226. For example, FPGA and/or GPU modules may be included both locally in the wearable computing device 130 as well as remotely in the form of one or more FPGA and/or GPU clusters in the external resources 226. FPGAs can allow multiple data streams to come in at the same time and FPGAs can also be capable of executing complex mathematical operations such as Fourier transforms in real time.

In some implementations, sensor data can first be received by the sensor data collection module 208 of the wearable computing device 130. The sensor data can include multiple data streams that may then be received in parallel by the AI algorithm module 210 from the sensor data collection module 208. The AI algorithm module 210 can be or can include an FPGA (or software instructions to perform similar functionality) and can perform mathematical operations such as max-pooling and/or convolution on the received data to produce a set of processed data.

After a particular chunk of data is processed through the AI algorithm module 210, it can be stored in a buffer (e.g., implemented by the electronic storage 228) which can be cleared depending on a data chunk size declared in the system 200. In some implementations, the data management module 212 can compress this processed data, and can transmit it to a cloud-based FPGAaaS (FPGA as a Service), which can be implemented as part of the external resources 226. Thus, the training of the DNN can be performed remotely within the external resources 226, which can include multiple FPGA clusters and/or GPU clusters that can handle training the machine learning model more efficiently than the wearable computing device 130. The external resources 226 can compute the at least one weight, at least one layer, and at least one hyperparameter after training the DNN, and can create a metadata file. The metadata file can be cached on the external resources 226 to store the associated weights, layers, and hyperparameters necessary for implementing the DNN elsewhere.

Once the metadata file is cached on the external resources 226, a copy of the metadata file can be transmitted back to the wearable computing device 130 and received by the data management module 212. The data management module 212 can store the copy of the metadata file locally in the electronic storage 228, which may be or may include an electrically erasable programmable read-only memory (EEPROM) so that metadata file associated with the DNN will be present on the wearable computing device 130, even if the device is turned off. This makes the overall system 200 asynchronous in nature, because the data management module 212 can receive updated cached files whenever the FPGAaaS module implemented by the external resources updates the metadata to reflect more recent data streams.

The AI algorithm module 210 can then use the real time analyzed data coming from the sensor data collection module 208 to generate a prediction using the metadata file stored on the wearable computing device 130. For example, based on image data from the camera 110, the AI algorithm module 210 can determine a user's location within an airport and can generate a recommendation for turn-by-turn directions to the user's destination (e.g., a particular terminal or gate within the airport). Using this arrangement, the AI algorithm module 210 can make predictions at a much faster and more efficient rate, because the DNN or other machine learning model has already been trained on the cloud-based FPGAaaS within the external resources 226. The updated metadata file stored on the wearable computing device 130 can therefore be used to make predictions on the wearable computing device 130 itself.

In some implementations, the prediction outputting module 214 may be configured to output the prediction to the user of the wearable device 100. For example, the prediction outputting module 214 can cause the prediction to be delivered to an output device, such as the speakers 125 of the wearable device 100. In some implementations, the prediction outputting module 214 can output the prediction to one or more of the client computing platforms 204, which may include a handheld electronic device used by the traveler wearing the wearable device 100. Thus, the traveler is able to receive the prediction in real time.

In some implementations, wearable computing device(s) 130, client computing platform(s) 204, and/or external resources 226 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which wearable computing device(s) 130, client computing platform(s) 204, and/or external resources 226 may be operatively linked via some other communication media.

A given client computing platform 204 may include one or more processors configured to execute computer program modules. The computer program modules may be configured to enable an expert or user associated with the given client computing platform 204 to interface with system 200 and/or external resources 226, and/or provide other functionality attributed herein to client computing platform(s) 204. By way of non-limiting example, the given client computing platform 204 may include one or more of a desktop computer, a laptop computer, a handheld computer, a tablet computing platform, a NetBook, a Smartphone, a gaming console, and/or other computing platforms.

External resources 226 may include sources of information outside of system 200, external entities participating with system 200, and/or other resources. In some implementations, some or all of the functionality attributed herein to external resources 226 may be provided by resources included in system 200.

Wearable computing device(s) 130 may include electronic storage 228, one or more processors 230, and/or other components. Wearable computing device(s) 130 may include communication lines, or ports to enable the exchange of information with a network and/or other computing platforms. Illustration of wearable computing device(s) 130 in FIG. 2 is not intended to be limiting. Wearable computing device(s) 130 may include a plurality of hardware, software, and/or firmware components operating together to provide the functionality attributed herein to wearable computing device(s) 130. For example, wearable computing device(s) 130 may be implemented by a cloud of computing platforms operating together as wearable computing device(s) 130.

Electronic storage 228 may comprise non-transitory storage media that electronically stores information. The electronic storage media of electronic storage 228 may include one or both of system storage that is provided integrally (i.e., substantially non-removable) with wearable computing device(s) 130 and/or removable storage that is removably connectable to wearable computing device(s) 130 via, for example, a port (e.g., a USB port, a firewire port, etc.) or a drive (e.g., a disk drive, etc.). Electronic storage 228 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 228 may include one or more virtual storage resources (e.g., cloud storage, a virtual private network, and/or other virtual storage resources). Electronic storage 228 may store software algorithms, information determined by processor(s) 230, information received from wearable computing device(s) 130, information received from client computing platform(s) 204, and/or other information that enables wearable computing device(s) 130 to function as described herein.

Processor(s) 230 may be configured to provide information processing capabilities in wearable computing device(s) 130. As such, processor(s) 230 may include one or more of a digital processor, an analog processor, a digital circuit designed to process information, an analog circuit designed to process information, a state machine, and/or other mechanisms for electronically processing information. Although processor(s) 230 is shown in FIG. 2 as a single entity, this is for illustrative purposes only. In some implementations, processor(s) 230 may include a plurality of processing units. These processing units may be physically located within the same device, or processor(s) 230 may represent processing functionality of a plurality of devices operating in coordination. Processor(s) 230 may be configured to execute modules 208, 210, 212, 214, and/or other modules. Processor(s) 230 may be configured to execute modules 208, 210, 212, 214, and/or other modules by software; hardware; firmware; some combination of software, hardware, and/or firmware; and/or other mechanisms for configuring processing capabilities on processor(s) 230. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, and/or 214 are illustrated in FIG. 2 as being implemented within a single processing unit, in implementations in which processor(s) 230 includes multiple processing units, one or more of modules 208, 210, 212, and/or 214 may be implemented remotely from the other modules. The description of the functionality provided by the different modules 208, 210, 212, and/or 214 described below is for illustrative purposes, and is not intended to be limiting, as any of modules 208, 210, 212, and/or 214 may provide more or less functionality than is described. For example, one or more of modules 208, 210, 212, and/or 214 may be eliminated, and some or all of its functionality may be provided by other ones of modules 208, 210, 212, and/or 214. As another example, processor(s) 230 may be configured to execute one or more additional modules that may perform some or all of the functionality attributed below to one of modules 208, 210, 212, and/or 214.

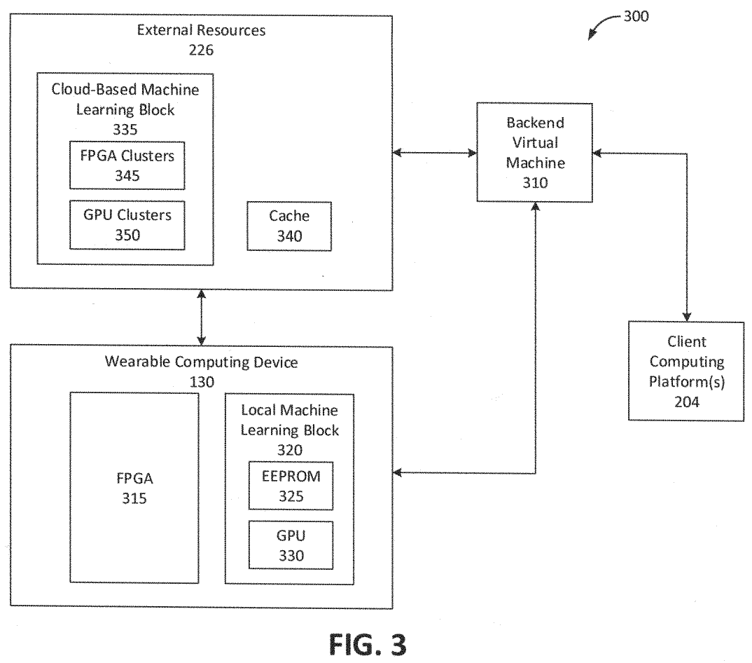

FIG. 3 illustrates a system 300 configured for providing navigation directions, in accordance with one or more implementations. The system 300 can be an example implementation of the system 200 shown in FIG. 2. For example, the system 300 includes the wearable computing device 130, client computing platform(s) 204, and external resources 226. The system 300 also can include a backend virtual machine 310. The wearable computing device 130 can include an FPGA 315 and a machine learning block 320. The machine learning block 320 can include an EEPROM 325 and a GPU 330.

Together, the components of the wearable computing device 130 shown in FIG. 3 can perform functions similar to those described above in connection with FIG. 2. For example, the FPGA 315 can be used to implement at least some of the functionality described above in connection with the sensor data collection module 208 of FIG. 2, and the local machine learning block 320 and its EEPROM 325 and GPU 330 can be used to implement at least some of the functionality of the AI algorithm module 210, the data management module 212, and the prediction outputting module 214. In general, any combination of the components of the wearable computing device 130 shown in FIG. 3 can be used to implement the functionality of any combination of the components of the wearable computing device 130 shown in FIG. 2.

The external resources 226 can include a cloud-based machine learning block 335 and a cache 340. The cloud-based machine learning block 335 can include FPGA clusters 345 and GPU clusters 350. Together, the FPGA clusters 345 and GPU clusters 350 of the cloud-based machine learning block can be used to perform computations for training one or more machine learning models, such as a DNN, as described above. Data associated with the machine learning model, such as weights, layers, and hyperparameters, can be stored in the cache 340.

The backend virtual machine 310 can be configured to receive information from both the wearable computing device 130 and the external resources 226. In some implementations, the backend virtual machine 310 can facilitate communication of data between either the wearable computing device 130 or the external resources 226 and the client computing platform(s) 204.

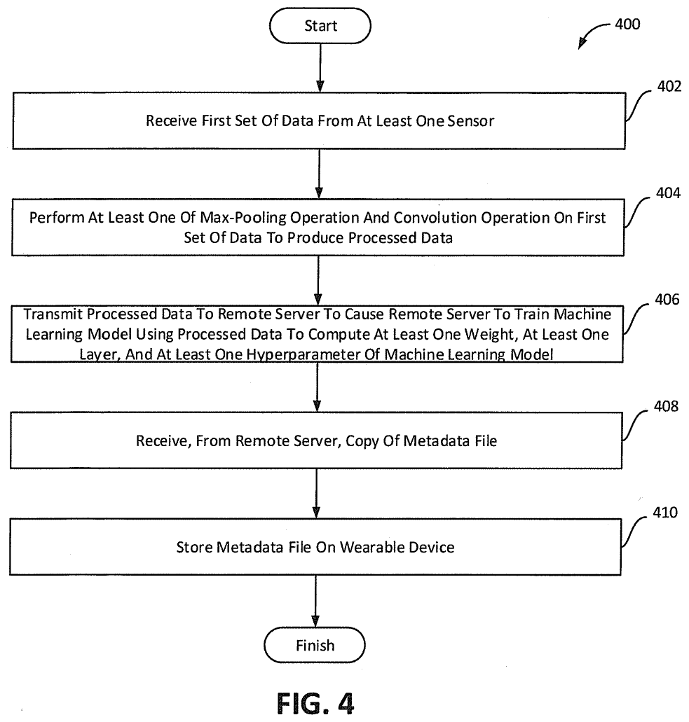

FIG. 4 illustrates a method 400 for providing navigation directions, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include receiving a first set of data from at least one sensor. For example, the first set of data can be received by an FPGA. The FPGA and the at least one sensor can be included in a wearable device worn by a user, such as the wearable device 100 shown in FIG. 1A. Operation 402 may be performed by one or more hardware processors configured by machine-readable instructions including a module that is the same as or similar to sensor data collection module 208, in accordance with one or more implementations.

An operation 404 may include performing at least one of a max-pooling operation and a convolution operation on the first set of data to produce processed data. Operation 404 may be performed by one or more hardware processors configured by machine-readable instructions including a module that is the same as or similar to AI algorithm module 210, in accordance with one or more implementations.

An operation 406 may include transmitting the processed data to a remote server to cause the remote server to train a machine learning model using the processed data to compute at least one weight, at least one layer, and at least one hyperparameter of the machine learning model. The remote server may store a metadata file including the at least one weight, the at least one layer, and the at least one hyperparameter of the machine learning model. Operation 406 may be performed by one or more hardware processors configured by machine-readable instructions including a module that is the same as or similar to data management module 212, in accordance with one or more implementations.

An operation 408 may include receiving, from the remote server, a copy of the metadata file. Operation 408 may be performed by one or more hardware processors configured by machine-readable instructions including a module that is the same as or similar to data management module 212, in accordance with one or more implementations.

An operation 410 may include storing the metadata file on the wearable device. Operation 410 may be performed by one or more hardware processors configured by machine-readable instructions including a module that is the same as or similar to data management module 212, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing navigation directions, the system comprising:
one or more hardware processors configured by machine-readable instructions to:
receive, by a field programmable gate array (FPGA), a first set of data from at least one sensor, the FPGA and the at least one sensor included in a wearable device worn by a user;
perform at least one of a max-pooling operation and a convolution operation on the first set of data to produce processed data;
transmit the processed data to a remote server to cause the remote server to train a machine learning model using the processed data to compute at least one weight, at least one layer, and at least one hyperparameter of the machine learning model, the remote server storing a metadata file including the at least one weight, the at least one layer, and the at least one hyperparameter of the machine learning model;
receive, from the remote server, a copy of the metadata file; and
store the metadata file on the wearable device.

2. The system of claim 1, wherein the one or more hardware processors are further configured by machine-readable instructions to compress the processed data prior to transmitting the processed data to the remote server.

3. The system of claim 1, wherein the machine learning model comprises a neural network.

4. The system of claim 1, wherein the one or more hardware processors are further configured by machine-readable instructions to receive a second set of data from the at least one sensor on the wearable device.

5. The system of claim 4, wherein the one or more hardware processors are further configured by machine-readable instructions to process the second set of data via an instance of the machine learning model and the metadata file stored on the wearable device to generate a prediction relating to a navigation direction.

6. The system of claim 5, wherein the one or more hardware processors are further configured by machine-readable instructions to output the prediction to the user of the wearable device.

7. A method for providing navigation directions, the method comprising:
receiving, by a field programmable gate array (FPGA), a first set of data from at least one sensor, the FPGA and the at least one sensor included in a wearable device worn by a user;
performing at least one of a max-pooling operation and a convolution operation on the first set of data to produce processed data;
transmitting the processed data to a remote server to cause the remote server to train a machine learning model using the processed data to compute at least one weight, at least one layer, and at least one hyperparameter of the machine learning model, the remote server storing a metadata file including the at least one weight, the at least one layer, and the at least one hyperparameter of the machine learning model;
receiving, from the remote server, a copy of the metadata file; and
storing the metadata file on the wearable device.

8. The method of claim 7, further comprising compressing the processed data prior to transmitting the processed data to the remote server.

9. The method of claim 7, wherein the machine learning model comprises a neural network.

10. The method of claim 7, further comprising receiving a second set of data from the at least one sensor on the wearable device.

11. The method of claim 10, further comprising processing the second set of data via an instance of the machine learning model and the metadata file stored on the wearable device to generate a prediction relating to a navigation direction.

12. The method of claim 11, further comprising outputting the prediction to the user of the wearable device.

13. A non-transient computer-readable storage medium having instructions embodied thereon, the instructions being executable by one or more processors to perform a method for providing navigation directions, the method comprising:
receiving, by a field programmable gate array (FPGA), a first set of data from at least one sensor, the FPGA and the at least one sensor included in a wearable device worn by a user;
performing at least one of a max-pooling operation and a convolution operation on the first set of data to produce processed data;
transmitting the processed data to a remote server to cause the remote server to train a machine learning model using the processed data to compute at least one weight, at least one layer, and at least one hyperparameter of the machine learning model, the remote server storing a metadata file including the at least one weight, the at least one layer, and the at least one hyperparameter of the machine learning model;
receiving, from the remote server, a copy of the metadata file; and
storing the metadata file on the wearable device.

14. The computer-readable storage medium of claim 13, wherein the method further comprises compressing the processed data prior to transmitting the processed data to the remote server.

15. The computer-readable storage medium of claim 13, wherein the machine learning model comprises a neural network.

16. The computer-readable storage medium of claim 13, wherein the method further comprises receiving a second set of data from the at least one sensor on the wearable device.

17. The computer-readable storage medium of claim 16, wherein the method further comprises processing the second set of data via an instance of the machine learning model and the metadata file stored on the wearable device to generate a prediction relating to a navigation direction.

18. The computer-readable storage medium of claim 17, wherein the method further comprises outputting the prediction to the user of the wearable device.
